(19) United States
(12) Patent Application Publication
(10) Pub. No.: US 2010/0143235 A1
(43) Pub. Date: Jun. 10, 2010

(54) Method of manufacturing carbon nanofiber and apparatus for manufacturing the same

(76) Inventors: Joon-Hee Jeong, Sugi-gu (KR); Jun Ho Choi, Suwon-si (KR); Jin Ho Lee, Suwon-si (KR)

Correspondence Address: MCDERMOTT WILL & EMERY LLP, 600 13TH STREET, N.W., WASHINGTON, DC, 20005-3096, US

(21) Appl. No.: 11/513,413

(22) Filed: Aug. 31, 2006

(30) Foreign Application Priority Data
Aug. 17, 2006 (KR) 10-2006-0077848

(51) Int. Cl. D01F 9/12; B06B 1/00

(52) U.S. Cl. 423/447.4; 422/128; 977/896

(57) ABSTRACT

The present invention provides a method of manufacturing a carbon nanofiber of the present invention including dissolving a catalyst-precursor and a supporter-precursor into a solvent of a hydrocarbon-based compound to prepare a reacting solution, atomizing the reacting solution, thermally decomposing the atomized reacting solution to forming particles of the carbon nanofiber, and collecting the particles of the carbon nanofiber. In accordance with the above method, the carbon nanofiber is efficiently mass-produced in situ process and in batch process.

### CROSS-REFERENCE TO RELATED APPLICATION

The present application claims priority from Korean Patent Application No. 2006-77848, filed on Aug. 17, 2006, in the Korean Intellectual Property Office, the entire disclosure of which is incorporated herein by reference.

### BACKGROUND OF THE INVENTION

1. Field of the Invention

The present invention relates to a method of manufacturing a carbon nanofiber and an apparatus for manufacturing the same. More particularly, the present invention relates to a method of manufacturing a carbon nanofiber capable of efficiently mass-producing a finely powdered carbon nanofiber having a size of about a few nanometers to about a few micrometers, and an apparatus capable of manufacturing the carbon nanofiber continuously by applying a simplified process.

2. Description of the Related Art

Generally, a carbon nanotube or a carbon nanofiber is generally applied to a electro-luminescent display device, a transistor, a gas sensor, a complex body, a secondary battery, a fuel cell, a medium for storing hydrogen, a nano-scaled device, etc., due to a characteristic of the carbon nanotube or the carbon nanofiber such as structural characteristic, an electric characteristic, an optical characteristic, an electronic characteristic, etc. Therefore, the carbon nanofiber is widely studied recently.

Various methods such as an arc discharge, a laser deposition, a plasma enhanced chemical vapor deposition, a thermal chemical vapor deposition and vapor phase growth are widely known to as a method of manufacturing carbon nanofiber.

Particularly, the method of vapor phase growth is applied to the mass-producing process. According to the method of vapor phase growth, a hydrocarbon-based compound such as acetylene, ethylene or methane is used as a source material. The carbon nanofiber is manufactured by using a transition metal such as nickel, cobalt and iron as a catalyst. The transition metal is used for nucleation of catalytic reaction.

However, the method of vapor phase growth requires two step processes so as to synthesize the carbon nanofiber. One is a process for preparing the catalyst, and another process is a reacting process between a source gas and the catalyst in the vapor phase growth vessel.

Therefore, the method of manufacturing the carbon nanofiber that is relatively simplified is required so as to improve an efficiency during a manufacturing process of the carbon nanofiber.

### SUMMARY OF THE INVENTION

The present invention provides a method of manufacturing a carbon nanofiber, and a finely powdered carbon nanofiber having a size of from a few nanometer to a few micrometer may be effectively mass-produced by using the method of the present invention.

The present invention also provides an apparatus for manufacturing a carbon nanofiber, and the apparatus of the present invention may realize the above method in situ and also under batch process.

In one aspect of the present invention, a method of manufacturing a carbon nanofiber comprises atomizing a mixed solution consisting of a catalyst-precursor, a supporter-precursor and a solvent of a hydrocarbon-based compound and thermally decomposing the mixed solution that is atomized.

More specifically, in order to produce the carbon nanofiber in one aspect of the present invention, a catalyst-precursor and a supporter-precursor is dissolved into a solvent of hydrocarbon-based compound to prepare a reacting solution. The reacting solution is atomized by using a predetermined method. The atomized reacting solution is thermally decomposed to form particles of the carbon nanofiber. The powdered carbon nanofiber is collected by a predetermined collecting method.

The catalyst-precursor may include a metal salt containing iron, nickel, cobalt, palladium, tungsten, chrome, iridium, or a mixture thereof. The metal salt may present in a form of a hydrate.

A supplemental catalyst including a molybdic salt or a molybdic acid may be additionally used.

The solvent of hydrocarbon-based compound may include an alcohol-based compound or an aromatic hydrocarbon. A concentration of the catalyst-precursor in the reacting solution may be in a range of about 0.1M to about 10M.

The atomization of the reacting solution may be performed by a nozzle-spraying method or an ultrasonic spraying method.

The thermal decomposition of the atomized reacting solution may be performed at a temperature in a range of about 700° C. to 1200° C.

In another aspect of the present invention, an apparatus for manufacturing a carbon nanofiber comprises a solution-generating unit that mixes a catalyst precursor and a supporter-precursor with a solvent of a hydrocarbon-based compound to form a reacting solution, an atomizing unit that receives the reacting solution from the solution-generating unit and atomizes the reacting solution, a thermal decomposing unit that receives the atomized reacting solution from the atomizing unit and thermally decomposes the atomized reacting solution to form particles of the carbon nanofiber and a collecting unit that collects the particles of the carbon nanofiber.

A nozzle-typed spraying apparatus or an ultrasonic spraying apparatus may be used as the atomizing unit.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a cross-sectional view schematically illustrating an apparatus for manufacturing a carbon nanofiber in accordance with an exemplary embodiment of the present invention; and

FIG. 2 is a cross-sectional view schematically illustrating an apparatus for manufacturing a carbon nanofiber in accordance with another, exemplary embodiment of the present invention.

### DETAILED DESCRIPTION OF THE INVENTION

Hereinafter, the present invention will be described in detail. It should be apparent that the invention may be modified in arrangement and detail without departing from following principles.

Method of Manufacturing a Carbon Nanofiber

A method of manufacturing a carbon nanofiber of the present invention includes i) dissolving a catalyst-precursor and a supporter-precursor into a solvent of a hydrocarbon-based compound to prepare a reacting solution, ii) atomizing the reacting solution, iii) thermally decomposing the atomized reacting solution to forming particles of the carbon nanofiber, and iv) collecting the particles of the carbon nanofiber.

In the thermal decomposition of the reacting solution, the catalyst-precursor is converted into a catalyst, and the supporter-precursor is converted into a supporter for supporting the catalyst. The supporter is coupled to the catalyst to form a catalyst-supporter so that the catalyst may be uniformly dispersed without aggregation between catalyst particles. The catalyst-supporter corresponds to the catalyst that is supported by the supporter. The catalyst-supporter induces a reaction between the hydrocarbon-based compounds.

More specifically, a final product of the carbon nanofiber particles may be coupled with the catalyst-supporter.

The catalyst-precursor includes a transition metal. The catalyst-precursor may include a metal salt, and the metal salt may contain iron, nickel, cobalt, palladium, tungsten, chrome, iridium, or mixture thereof. Also, the metal salt may present in a form of a hydrate. That is, the catalyst-precursor may include the hydrate such as Fe(NO₃)₂.9H₂O, Ni(NO₃)₂.6H₂O, Co(NO₃)₂.6H₂O, etc.

The catalyst-precursor may further comprise a supplemental catalyst such as a molybdic salt, a molybdic acid and so on. The molybdic salt may include (NH₄)₆Mo₇O₂₄.4H₂O.

The supporter-precursor for supporting the catalyst may include an oxide or nitrate, or hydrate thereof. The supporter-precursor may include a magnesium salt such as magnesium nitrate. More specifically, Mg(NO₃)₃.6H₂O may be used as the supporter-precursor. The supporter-precursor is converted into the supporter in a form of the oxide during the thermal decomposition process, and then the supporter is coupled to the catalyst to form a catalyst-supporter. The catalyst-supporter entirely functions as a catalyst, and synthesis the carbon nanofiber from the solvent of the hydrocarbon-based compound. Above processes are occurred automatically during the thermal decomposition.

The solvent of the hydrocarbon-based compound may include an alcohol-based compound, aromatic hydrocarbon, and so on. The hydrocarbon-based compound in here has a liquid state at a room temperature. Above compound may be used alone or in a mixture thereof.

When a concentration of the catalyst-precursor is less than 0.1M, a synthetic process of the carbon nanofiber may not be performed effectively. Otherwise, when the concentration of the catalyst-precursor excess 10M, an extra product that is undesired or an amorphous crystalline carbon may be generated.

In different aspect, when the concentration of the catalyst-precursor excesses 10M, the atomization of the reacting solution may be sufficiently performed by using the nozzle-spraying method or the ultrasonic spraying method since the concentration of the precursors relatively extremely high. Otherwise, when the concentration of the catalyst-precursor is less than 0.1M, an efficiency of the succeeding processes may decrease.

Therefore, the concentration of the catalyst-precursor in the reaction solution is preferably in a range of about 0.1M to about 10M.

A content of the catalyst-precursor and supporter-precursor may be controlled in allowance for a kind of the precursors, a shape of the carbon nanofiber that is finally acquired, and a yield of the carbon nanofiber and so on.

The catalyst-precursor and supporter-precursor is dissolved in the solvent of the hydrocarbon-based compound for about 1 hr to about 2 hr, so that the reaction solution for synthesis of the carbon nanofiber may be prepared.

The reacting solution may be sufficiently stirred so that the precursors may be uniformly mixed to the solvent. The dissolving process is performed at a room temperature.

When the reacting solution is prepared, the reacting solution is atomized by using a nozzle-spraying apparatus or an ultrasonic spraying apparatus.

The reacting solution may be atomized in a relatively short time by using the nozzle-spraying method, however, a uniformity of the shape of the carbon nanofiber that is acquired. Otherwise, the reacting solution may be atomized in a relatively long time, however, the uniformity of the shape of the carbon nanofiber that is acquired.

Alternatively, various atomizing methods may be used with allowance for characteristics of the process that is required by an operator.

Particles in the reaction solution are sintered to be powdered during the thermal decomposing process.

That is, the catalyst-precursor is converted into the catalyst, and the supporter-precursor is converted into the oxide. Also, the transition metal that is catalyst is coupled to the oxide to form a transition metal-oxide complex during the thermal decomposing process.

And then, hydrocarbon-based compound is converted into the carbon nanofiber by a catalytic reaction between the solvent and the transition metal-oxide complex as the catalyst.

When a temperature for thermal decomposing process is less than 700° C., a transition metal-precursor and the solvent of the hydrocarbon-based compound may not be sufficiently decomposed, so that compounds that are not decomposed may be remained, to thereby generate a condensation of the solvent. Otherwise, when the temperature for thermal decomposing process excesses 1200° C., the shape of the acquired carbon nanofiber may be non-uniform and extra products may be generated.

Therefore, the thermal decomposition of the atomized reacting solution is performed preferably at a temperature in a range of about 700° C. to 1200° C.

The acquired powder-typed carbon nanofiber is separated from gas materials generated during the thermal decomposing process, so that the powder-typed carbon nanofiber may be collected.

The carbon nanofiber acquired by the method of the present invention has a size of about a few nanometers to about a few micrometers.

Hereinafter, the present invention will be described in detail with reference to a following example. Although the example of the present invention is shown in below, the present invention is not limited to the described example. Instead, it would be appreciated by those skilled in the art that changes may be made to this example without departing from the principles and spirit of the invention, the scope of which is defined by the claims and their equivalents.

### Example 1

Fe(NO₃)₂.9H₂O, MoO₃ and MgO were dissolved into about 5 L of ethanol so that an atomic ratio of Fe:Mo:Mg was 19:1:80 to uniformly mixed the above compounds at a room temperature by using a mixer. Then, the mixed solution was injected into a nozzle-typed spraying apparatus and sprayed into the reacting container that is preheated up to about 750° C. through the nozzle-typed spraying apparatus. The mixed solution is sprayed by a speed of about 35 L/min, and spraying gas (nitrogen) is used for spraying the mixed solution. After the reaction is finalized, fine powder having color of black was acquired. The fine powder was confirmed as a carbon nanofiber having an outer diameter of about 20 nm to about 50 nm. Also, the carbon nanofiber was confirmed to be coupled to a catalyst supported by the supporter.

An Apparatus for Manufacturing a Carbon Nanofiber

Hereinafter, an apparatus for manufacturing a carbon nanofiber in accordance with the preferred embodiment of the present invention will be described in detail with reference to the accompanied drawings.

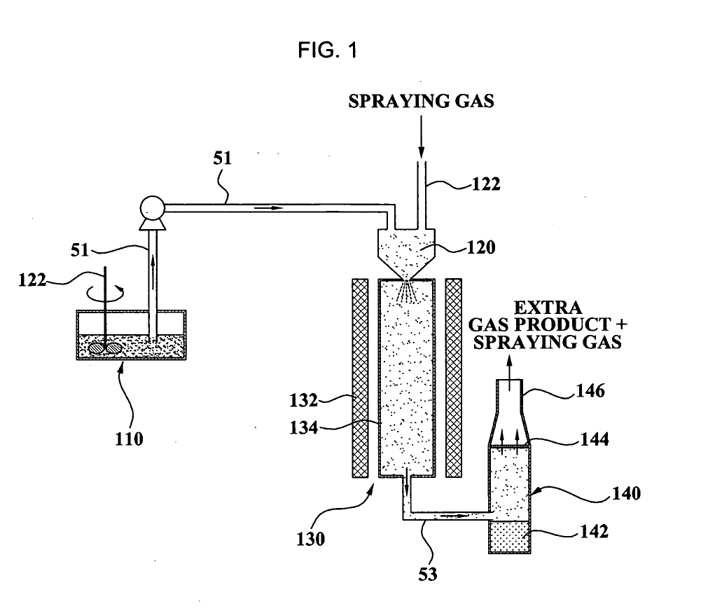

FIG. 1 is a cross-sectional view schematically illustrating an apparatus for manufacturing a carbon nanofiber in accordance with an exemplary embodiment of the present invention.

Referring to FIG. 1, an apparatus for manufacturing a carbon nanofiber includes a solution-generating unit 110, an atomizing unit 120, a thermal decomposing unit 130 and a collecting unit 140.

A reacting solution is prepared by mixing a catalyst-precursor and supporter-precursor with a solvent of hydrocarbon-based compound and stirring them in the solution-generating unit 110. In the present embodiment, the solution-generating unit 110 further includes a stirrer 112 so that the reacting solution may be efficiently generated.

The atomizing unit 120 receives the reacting solution from the solution-generating unit 110 to atomize the reacting solution. Therefore, the reacting solution may be converted into the atomized (sprayed) fine particles. The atomizing unit 120 includes an inlet 122 for receiving a spraying gas. The spraying gas is injected through the inlet 122 and allows the atomized particles for discharging from the inlet 122 into the thermal decomposing unit 130 naturally. The atomized reacting solution is moved into the thermal decomposing unit 130 by the spraying gas. The spraying gas may include a nitrogen gas.

In the present embodiment, a nozzle-typed spraying apparatus is used as an atomizing unit 120. The nozzle-typed spraying apparatus atomizes the reacting solution by decreasing pressure of the reacting solution having a high pressure when the reacting solution is passed through a narrow nozzle.

The reacting solution prepared at the solution-generating unit 110 is transferred to the nozzle-typed spraying apparatus 120 through a first transferring tube 51.

The atomized mixed solution at the nozzle-typed spraying apparatus 120 is provided to the thermal decomposing unit 130. The thermal decomposing unit 130 thermally decomposes the atomized reacting solution passed through the nozzle-typed spraying apparatus 120. Through the sintering in the thermal decomposing unit 130, a powdered catalyst-supporter is generated. Simultaneously, the solvent of the hydrocarbon-based compound is catalytically reacted to the catalyst-supporter, so that the carbon nanofiber is generated. During the decomposing process, extra gas product may be generated. Floating speed of the gas in the thermal decomposing unit 130 is preferably in a range of about 30 L/min to about 70 L/min. Also, a temperature for reaction at an inner space of the thermal decomposing unit 130 is preferably maintained in a range of about 700° C. to about 1200° C. When the temperature is less than 700° C., the precursors may not be decomposed. When the temperature excesses 1200° C., the reacting solution may be partially condensed in the collecting unit since the floating speed of the reacting solution is extremely low.

The thermal decomposing unit 130 is preferably heated to the predetermined temperature before the atomized reacting solution is provided to the thermal decomposing unit 130.

The thermal decomposing unit 130 includes a heater 132, thermal decomposing reaction vessel 134, and also is spatially connected to the nozzle-typed spraying unit 120. The heater 132 generates a heat to heat the inner space of the thermal decomposing reaction vessel 134. The atomized reacting solution is converted into the carbon nanofiber through the thermal decomposing reaction in the thermal decomposing reaction vessel 134. An extra gas product generated through the thermal decomposing reaction is transferred to the collecting unit 140.

The thermal decomposing unit 130 and the collecting unit 140 are connected to each other by a second transferring tube 53.

The collecting unit 140 receives the carbon nanofiber, the extra gas product and the spraying gas from the thermal decomposing unit 130. The collecting unit 140 collects the carbon nanofiber and discharges the extra gas product and the spraying gas to an outside.

The collecting unit 140 includes a collecting member 142, a blocking filter 144 and gas outlet 146.

The blocking filter 144 passes the extra gas product and the spraying gas, and blocks the powdered carbon nanofiber. The reaction product that is blocked by the blocking filter 144 is collected in the collecting member 142 that is placed at lower portion of the collecting unit 140. The gas outlet 146 discharges the gas including the extra gas product and spraying gas that are not blocked by the blocking filter 144. That is, the gas outlet 146 functions as a discharging path.

More specifically, the reaction product that is collected in the collecting unit 142 corresponds to the carbon nanofiber that is coupled to the catalyst-supporter. The catalyst-supporter is the catalyst supported by the supporter.

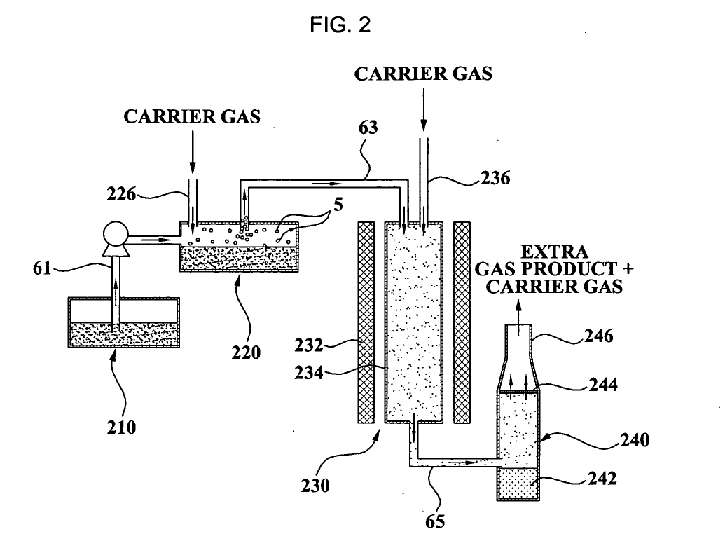

FIG. 2 is a cross-sectional view schematically illustrating an apparatus for manufacturing a carbon nanofiber in accordance with another exemplary embodiment of the present invention.

Referring to FIG. 2, an apparatus for manufacturing a carbon nanofiber includes a solution-generating unit 210, an ultrasonic spraying apparatus 220, a thermal decomposing unit 230 and collecting unit 240.

In the present embodiment, the apparatus for manufacturing a carbon nanofiber has same function and structure as those of the apparatus for manufacturing the carbon nanofiber in FIG. 1 except for an atomizing unit. Therefore, only different parts to the apparatus for manufacturing the carbon nanofiber will be described in here and any further repetitive descriptions will be omitted.

The ultrasonic spraying apparatus 220 receives a reacting solution from the solution-generating unit 110, and atomizes the reacting solution. Therefore, the reacting solution is converted to fine particles 5. The ultrasonic spraying apparatus 220 includes a first inlet 226 for receiving a first carrier gas. The first carrier gas is injected through the first inlet 226 so that the atomized reacting solution may be transferred from the ultrasonic spraying apparatus 220 to the thermal decomposing unit 230. The carrier gas may include a nitrogen gas.

The reacting solution generated in the solution-generating unit 210 is transferred to the ultrasonic spraying unit 230 by a first transferring tube 61.

The atomized reacting solution atomized at the ultrasonic spraying apparatus 220 is transferred to the thermal decomposing unit 230 by a second transferring tube 63.

Through a second inlet 236 for a second carrier gas, the second carrier gas is injected such as the nitrogen gas as like as the first carrier gas. The second inlet 236 is formed at one side of the thermal decomposing reaction vessel 232. The injected carrier gas through the second inlet transfers the thermal decomposing reaction product such as the carbon nanofiber and an extra gas product to the collecting unit 240.

The thermal decomposing unit 230 and the collecting unit 240 are spatially connected to each other by a third transferring tube 65. Further explanation will be omitted.

According to the present invention, a carbon nanofiber may be efficiently mass-produced by a simplified process in situ and in batch.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method of manufacturing a carbon nanofiber comprising:
atomizing a mixed solution consisting of a catalyst-precursor, a supporter-precursor and a solvent of a hydrocarbon-based compound; and
thermally decomposing the mixed solution that is atomized,
wherein the atomizing of the mixed solution is performed by an ultrasonic spraying method, and wherein the ultrasonic spraying method receives a first carrier gas from an external resource for the first carrier gas and transfers the atomized reacting solution by the first carrier gas.

2. A method of manufacturing a carbon nanofiber comprising:
dissolving a catalyst-precursor and a supporter-precursor into a solvent of a hydrocarbon-based compound to prepare a reacting solution;
atomizing the reacting solution;
thermally decomposing the atomized reacting solution to forming particles of the carbon nanofiber; and
collecting the particles of the carbon nanofiber,
wherein the atomizing of the reacting solution is performed by an ultrasonic spraying method, and wherein the ultrasonic spraying method receives a first carrier gas from an external resource for the first carrier gas and transfers the atomized reacting solution by the first carrier gas.

3. The method of manufacturing a carbon nanofiber of claim 2, wherein the catalyst-precursor is a metal salt containing at least one selected from a group consisting of iron, nickel, cobalt, palladium, tungsten, chrome and iridium.

4. The method of manufacturing a carbon nanofiber of claim 3, wherein the metal salt presents in a form of a hydrate.

5. The method of manufacturing a carbon nanofiber of claim 3, wherein the catalyst-precursor further comprises a supplemental catalyst including at least one selected from a group consisting of a molybdic salt and a molybdic acid.

6. The method of manufacturing a carbon nanofiber of claim 2, wherein the supporter-precursor comprises a metal salt containing at least one selected from a group consisting of aluminum, magnesium and silicon.

7. The method of manufacturing a carbon nanofiber of claim 2, wherein the hydrocarbon-based compound comprises an alcohol-based compound or an aromatic hydrocarbon.

8. The method of manufacturing a carbon nanofiber of claim 2, wherein a concentration of the catalyst-precursor in the reacting solution is in a range of about 0.1M to about 10M.

9. (canceled)

10. The method of manufacturing a carbon nanofiber of claim 2, wherein the thermal decomposition of the atomized reacting solution is performed at a temperature in a range of about 700° C. to 1200° C.

11. The method of manufacturing a carbon nanofiber of claim 2, wherein the particles of the nanofiber is coupled to a catalyst supported by the supporter (catalyst-supporter), and the catalyst supported by the supporter is formed by the thermal decomposition of the catalyst-precursor and the supporter-precursor.

12. An apparatus for manufacturing a carbon nanofiber comprising:
a solution-generating unit that mixes a catalyst precursor and a supporter-precursor with a solvent of a hydrocarbon-based compound to form a reacting solution;
an atomizing unit that receives the reacting solution from the solution-generating unit and atomizes the reacting solution;
a thermal decomposing unit that receives the atomized reacting solution from the atomizing unit and thermally decomposes the atomized reacting solution to form particles of the carbon nanofiber;
a collecting unit that collects the particles of the carbon nanofiber,
wherein the atomizing unit includes an ultrasonic spraying apparatus having a first inlet for receiving a first carrier gas from an external resource for the first carrier gas separate, the first carrier gas being used for transferring the atomized reacting solution to the thermal decomposing unit.

13. (canceled)
